(19) United States
(12) Patent Application Publication
(10) Pub. No.: US 2026/0193568 A1
(43) Pub. Date: Jul. 9, 2026

(54) WATER-DILUTABLE VOC-FREE CLEANING COMPOSITIONS

(71) Applicant: CHEMETALL GMBH, Frankfurt (DE)

(72) Inventors: Miguel Angel JAEN FRANCO, Canovelles (ES); Fco Javier RODRIGO, Canovelles (ES); Albert YANGUES, Lliça de vall (ES); David ESPINOS, Canovelles (ES)

(21) Appl. No.: 19/133,363

(22) PCT Filed: Dec. 18, 2023
(86) PCT No.: PCT/EP23/86390

§ 371 Date: May 28, 2025

(30) Foreign Application Priority Data
Dec. 19, 2022 (EP) 22214644.1

(51) Int. Cl. C11D 1/72; C11D 3/20

(52) U.S. Cl. CPC C11D 1/72; C11D 3/2055; C11D 3/2086

(57) ABSTRACT

Disclosed herein is a cleaning composition including: 40 to 90 wt.-% of glycol monoalkyl ethers (A); 10 to 60 wt.-% of hydroxy carboxylic acids (B); 0 to 10 wt.-% of surface active agents (C); and 0 to 10 wt.-% of further ingredients (D) which differ from (A), (B) and (C); all the above ingredients having a vapor pressure at 20° C. of less than 0.01 kPa, and/or an initial boiling point of more than 250° C. at a pressure of 101.3 kPa; and all wt.-% values being based on the total weight of the cleaning composition, and the combined amount of all ingredients being 100 wt.-%. Also disclosed herein is a method for removing a non-cured aqueous coating material from a surface making use of such cleaning composition or its dilution in an aqueous medium. Further disclosed herein is a method of using the cleaning composition, or its dilution in an aqueous medium, the method including using the cleaning composition or its dilution in an aqueous medium for cleaning substrates to which non-cured aqueous coating materials adhere.

The present invention relates to cleaning compositions based on a mixture of one or more water-soluble organic solvents with one or more hydroxyl carboxylic acids and being free of volatile organic solvents. The compositions are apt to be used in for removing a non-cured aqueous coating material from a surface. The invention further relates to the use of said cleaning compositions for cleaning surfaces to which non-cured aqueous coating materials adhere.

### BACKGROUND

The challenge of climate change, combined with the need to continuously increase productivity by improving time and cost of process, force the automotive industry to find optimal solutions to improve any process step throughout the manufacturing processes of an automotive body or parts thereof.

One process step in the treatment of an automotive body or part thereof concerns the step of applying a corrosion protective coating material thereon by dip-coating. Such step comprises contacting the automotive body or part thereof with an aqueous coating material, most often in an electrodeposition coating process. However, dip coating processes without electrodeposition are also possible with newly developed dip coat compositions.

Particularly, cathodic electrodeposition coating processes are effectively used to protect metallic surfaces, edges and cavities or hard-to-reach areas of automotive bodies and their parts against corrosion. The coating materials used in such processes are aqueous and typically based on epoxy resins or acrylic resins.

Despite of its effectiveness, dip-coating requires the use of dip-coating tanks, in the special case of electrodeposition coating so-called electrodeposition tanks. Such tanks, installations, and equipment must be cleaned regularly. This requires optimal removal of the dip-coating paint sticking to the surfaces of such tanks, installations and equipment, exterior surfaces, but also floor and the like.

Thus, there is a need for providing a highly-efficient paint cleaning technology including an efficient cleaning composition to clean the surfaces such tanks and associated installations getting into contact with the coating materials. The cleaning compositions should be apt to remove paint residues from a variety of metal substrates, such as stainless steel, coated steel, such as galvanized steel and the like, in a gentle manner without harming the equipment.

Besides a high cleaning efficiency and cleaning power, there is a need to provide environmentally compatible cleaning compositions, essentially free of volatile organic compounds (VOC), the cleaning compositions being apt to clean the dip-coating tanks, but also the exterior and interior parts of the dip-coating installations and equipment having been in contact with the coating material. By dissolving the remains of paint adhered to the surfaces of tanks, installations, such as pipes, and equipment, an effective cleaning should be achievable, not only cleaning the visible parts, but also the non-visible parts of such installations, particularly and even at high dilutions of the cleaning composition, if diluted in aqueous medium. The term “VOC-free” in the context of the present invention is to be understood in accordance with EU Directive 2010/75/EU, requiring a vapor pressure at 20° C. of less than 0.01 kPa for VOC-free substances and/or the Chinese standard GB 38508-2020, requiring an initial boiling point of more than 250° C., at standard pressure of 101.3 kPa, for VOC-free substances.

### SUMMARY

The aim of the present invention was achieved by providing a cleaning composition comprising
a. 40 to 90 wt.-% of one or more glycol monoalkyl ethers (A), which are selected from the group consisting of mono alkylene glycol monoalkyl ethers (A1), dialkylene glycol monoalkyl ethers (A2), trialkylene glycol monoalkyl ethers (A3), and tetraalkylene glycol monoalkyl ethers (A4);
b. 10 to 60 wt.-% of one or more hydroxy carboxylic acids (B);
c. 0 to 10 wt.-% of one or more surface active agents (C); and
d. 0 to 10 wt.-% of one or more further ingredients (D) which differ from (A), (B) and (C), selected from the group consisting of secondary amines, tertiary amines, and dicarboxylic acids;
   all the above ingredients having
i. a vapor pressure at 20° C. of less than 0.01 kPa, and/or
ii. an initial boiling point of more than 250° C. at a pressure of 101.3 kPa; all wt.-% values being based on the total weight of the cleaning composition, and the combined amount of all ingredients being 100 wt.-%.

The above cleaning composition and its preferred embodiments as described hereinafter, are also denoted as “cleaning composition according to the invention”, “cleaning composition of the invention” or “inventive cleaning composition”.

The “vapor pressure at a temperature of 20° C.” denotes the pressure exerted by a vapor in thermodynamic equilibrium with its condensed phases (solid or liquid) at a given temperature in a closed system. The respective vapor pressure values are determined as described in the experimental part of the invention. The vapor pressure must be understood as used in EU Directive 2010/75/EU.

The term “initial boiling point at a pressure of 101.3 kPa” denotes the boiling temperature, if a definite boiling point exists; and, if a boiling range exists, the temperature at which boiling starts. The initial boiling point must be understood as used in Chinese standard GB/T 38597-2020. The respective initial boiling point values are determined as described in the experimental part of the invention.

Further subject of the present invention is a method for removing a non-cured aqueous coating material from a surface, comprising the steps of
1. contacting a surface to which non-cured aqueous coating material adheres with a cleaning composition according to the invention or its dilution in an aqueous medium; and agitating the cleaning composition or its dilution in an aqueous medium, while the non-cured aqueous coating material dissolves and/or disperses therein,
2. removing the cleaning composition or its dilution in an aqueous medium and the therein dissolved and/or dispersed coating material from the surface, and
3. rinsing the surface with an aqueous medium.

The above method for removing a non-cured aqueous coating material and its preferred embodiments as described hereinafter, are also denoted as “method according to the invention,” “method of the invention” or “inventive method.”

Yet another subject of the present invention is the use of the cleaning compositions of the present inventions for cleaning surfaces to which non-cured aqueous coating material adheres.

The above use and its preferred embodiments as described hereinafter, are also denoted as “use according to the invention,” “use of the invention” or “inventive use.”

### DETAILED DESCRIPTION

### Cleaning Compositions of the Invention

The cleaning compositions of the present invention contain 40 to 90 wt.-% of one or more of the above glycol monoalkyl ethers (A), 10 to 60 wt.-% of one or more of the above hydroxy carboxylic acids (B), 0 to 10 wt.-% of one or more of the above surface active agents (C); and 0 to 10 wt.-% of one or more of the above further ingredients (D) which differ from (A), (B) and (C); all wt.-% values being based on the total weight of the cleaning composition, and the combined amount of all ingredients being 100 wt.-%. Any of the afore-mentioned (A), (B), (C) and (D) possessing a vapor pressure at 20° C. of less than 0.01 kPa, and/or an initial boiling point of more than 250° C. at a pressure of 101.3 kPa. Preferably, requirements i. and ii. regarding the vapor pressure and initial boiling point apply likewise to the cleaning composition.

The cleaning compositions of the invention are water-thinnable, particularly water-soluble and/or water-dispersible.

In the following the ingredients of the cleaning composition are described in more detail.

### Glycol Monoalkyl Ethers (A)

The glycol mono alkylethers (A) are selected from the group consisting of monoalkylene glycol monoalkyl ethers (A1), dialkylene glycol monoalkyl ethers (A2), trialkylene glycol monoalkyl ethers (A3), and tetraalkylene glycol monoalkyl ethers (A4), and, they possess a vapor pressure at 20° C. of less than 0.01 kPa, and/or an initial boiling point of more than 250° C. at a pressure of 101.3 kPa.

Preferably, the glycol monoalkylethers at least possess a vapor pressure at 20° C. (VP) of less than 0.01 kPa, more preferred they possess both a vapor pressure at 20° C. (VP) of less than 0.01 kPa, and an initial boiling point at a pressure of 101.3 kPa (IBP) of more than 250° C.

The one or more glycol monoalkyl ethers (A) are contained in the cleaning composition of the invention in an amount of 40 to 90 wt.-% or 50 to 90 wt.-%, preferably 55 to 85 wt.-%, more preferred 60 to 80 wt.-% and most preferred 65 to 75 wt.-% based on the total weight of the cleaning composition of the invention.

### Monoalkylene Glycol Monoalkyl Ethers (A1)

The mono alkylene glycol monoalkyl ethers are preferable selected from ethylene glycol monoalkyl ethers and propylene glycol monoalkyl ethers, which have the following formula HO—R—O—R^{a}, wherein R—O is an ethylene oxide residue or a propylene oxide residue, preferably an ethylene oxide residue, and R^{a} is a linear or branched alkyl residue having 6 to 10 carbon atoms, preferably 6 to 8 carbon atoms and most preferred 6 carbon atoms.

Thus, most preferred mono alkylene glycol monoalkyl ethers are ethylene glycol monohexyl ether (VP: 0.007 kPa; IBP: 208° C.) and propylene glycol monohexyl ether.

### Dialkylene Glycol Monoalkyl Ethers (A2)

The dialkylene glycol monoalkyl ethers are preferable selected from diethylene glycol monoalkyl ethers and dipropylene glycol monoalkyl ethers which have the following formula HO—(R—O—)₂R^{b}, wherein the two R—O residues are independently of each other ethylene oxide or propylene oxide residues, and R^{b} is a linear or branched alkyl residue having 4 to 10 carbon atoms, preferably 4 to 8 carbon atoms and most preferred 4 to 6 carbon atoms. Preferably both residues R—O are the same, even more preferred both residues R—O are ethylene oxide residues.

Thus, most preferred dialkylene glycol monoalkyl ethers are diethylene glycol monobutyl ether (VP: <0.01 kPa; IBP: 224° C.), diethylene glycol monopentyl ether, diethylene glycol monohexyl ether (VP: <0.001 kPa; IBP: 240° C.), dipropylene glycol monobutylether (VP: 0.006 kPa; IBP: 229° C.), dipropylene glycol monopentyl ether and diethylene glycol monohexyl ether. The diethylene glycol monobutyl, diethylene glycol monopentyl ether, diethylene glycol monohexyl ether being even more preferred.

### Trialkylene Glycol Monoalkyl Ethers (A3)

The trialkylene glycol monoalkyl ethers are preferable selected from triethylene glycol monoalkyl ethers and tripropylene glycol monoalkyl ethers which have the following formula HO—(R—O—)₃R^{c}, wherein the three R—O residues are independently of each other ethylene oxide or propylene oxide residues, and R^{c} is a linear or branched alkyl residue having 1 to 10 carbon atoms, preferably 2 to 8 carbon atoms and most preferred 4 to 6 carbon atoms. Preferably all residues R—O are the same, even more preferred all residues R—O are ethylene oxide residues.

Thus, most preferred trialkylene glycol monoalkyl ethers are triethylene glycol monomethyl ether (VP: 0.001 kPa; IBP: 245° C.), triethylene glycol monoethyl ether (VP: <0.001 kPa; IBP: 255° C.), triethylene glycol monopropyl ether, triethylene glycol monobutyl ether (VP: <0.001 kPa; IBP: 300° C.), and tripropylene glycol monobutylether (VP: <0.001 kPa; IBP: 274° C.).

### Tetraalkylene Glycol Monoalkyl Ethers (A4)

The tetraalkylene glycol monoalkyl ethers are preferable selected from tetraethylene glycol monoalkyl ethers and tetrapropylene glycol monoalkyl ethers which have the following formula HO—(R—O—)₄R^{d}, wherein the four R—O residues are independently of each other ethylene oxide or propylene oxide residues, and R^{d} is a linear or branched alkyl residue having 1 to 10 carbon atoms, preferably 2 to 8 carbon atoms and most preferred 4 to 6 carbon atoms. Preferably all residues R—O are the same, even more preferred all residues R—O are ethylene oxide residues.

Thus, most preferred tetraalkylene glycol monoalkyl ethers are tetraethylene glycol monomethyl ether (VP: <0.001 kPa; IBP: 280° C.), and tetraethylene glycol monobutyl ether (VP: <0.001 kPa; IBP: 300° C.).

The one or more glycol mono alkylethers (A) are contained in the cleaning composition of the invention in an amount from 40 to 90 wt.-% or 50 to 90 wt.-%, preferably 55 to 84.9 wt.-%, more preferred 60 to 79.8 wt.-% and most preferred 65 to 75.6 wt.-% based on the total weight of the cleaning composition of the invention.

Amongst the above glycol mono alkylethers (A), the mono alkylene glycol monoalkyl ethers (A1), dialkylene glycol monoalkyl ethers (A2), trialkylene glycol monoalkyl ethers (A3); and mixtures thereof are most preferred; and amongst the afore-mentioned, in case of (A2) and (A3), the monobutyl ethers and monohexyl ethers, and in case of (A1) the monohexyl ethers are particularly preferred.

Even more preferred amongst the above glycol mono alkylethers (A), are the mono ethylene glycol monoalkyl ethers (A1), diethylene glycol monoalkyl ethers (A2), triethylene glycol monoalkyl ethers (A3); and mixtures thereof; and amongst the afore-mentioned, in case of (A2) and (A3), the monobutyl ethers and monohexyl ethers, and in case of (A1), the monohexyl ethers are particularly preferred.

Most preferably, the one or more of the above glycol mono alkylethers (A), comprise or consist of the mono alkylene glycol monoalkyl ethers (A1) and dialkylene glycol monoalkyl ethers (A2); and mixtures thereof; and amongst the afore-mentioned, in case of (A2), the monobutyl ethers and monohexyl ethers, and in case of (A1), the monohexyl ethers are particularly preferred.

Even more preferred, the one or more of the above glycol mono alkylethers (A), comprise or consist of mono ethylene glycol monoalkyl ethers (A1) and diethylene glycol monoalkyl ethers (A2); and mixtures thereof; and amongst the afore-mentioned, the monobutyl ethers and monohexyl ethers are particularly preferred.

Especially preferred as the one or more of the above glycol mono alkylethers (A) are mixtures comprising or consisting of at least two of the following: mono ethylene glycol monohexyl ether (A1), diethylene glycol monohexyl ether (A2) and diethylene glycol monobutyl ether (A2). Amongst the afore-mentioned glycol mono alkylethers (A), diethylene glycol monohexyl ether (A2) and diethylene glycol monobutyl ether (A2) are most preferred, thus the glycol mono alkylethers (A) preferably comprise or consist of a mixture diethylene glycol monohexyl ether (A2) and diethylene glycol monobutyl ether (A2). If the glycol mono alkylethers (A) consist of a mixture of mono ethylene glycol monohexyl ether (A1), diethylene glycol monohexyl ether (A2) and diethylene glycol monobutyl ether (A2), the combined amount of the latter two ethers (A2) is preferably in the range from 50 to 100 wt.-%, more preferred in the range from 60 to 99 wt.-%, even more preferred in the range from 70 to 98.5 wt.-% and most preferred in the range from 80 to 98 wt.-% based on the total amount of the glycol mono alkylethers (A), and the amount of the ether (A1) in this mixture is the difference to 100 wt.-% based on the total amount of the glycol mono alkylethers (A).

### Hydroxy Carboxylic Acids (B)

While acetic acid and formic acid, do not possess an effective cleaning property, it was the inventors of the present invention who found that hydroxy carboxylic acids, particularly monomeric hydroxy carboxylic acids comprising at least one, preferably one COOH and at least one, preferably one OH group, and possess a vapor pressure at 20° C. of less than 0.01 kPa, are most efficient in the cleaning compositions of the present invention, if combined with the glycol mono alkylethers (A) as described above.

It is most preferred that the hydroxy carboxylic acid is an alpha-hydroxy carboxylic acid, also denoted as alpha-hydroxy acid (AHA) in literature. The alpha-hydroxy carboxylic acid preferably contains one or two hydroxyl groups and one, two or three carboxylic acid groups, wherein at least one of the hydroxy groups is in alpha-position to at least one of the carboxylic acid groups.

Particularly preferred amongst the alpha-hydroxy acids are monohydroxy monocarboxylic acids, monohydroxy dicarboxylic acids, monohydroxy tricarboxylic acids, dihydroxy monocarboxylic acids, dihydroxy dicarboxylic acids, and dihydroxy tricarboxylic acids; even more preferred are monohydroxy monocarboxylic acids, monohydroxy dicarboxylic acids, monohydroxy tricarboxylic acids, and dihydroxy dicarboxylic acids.

Preferred examples of monohydroxy monocarboxylic acids are lactic acid, glycolic acid and mandelic acid, amongst which glycolic acid and mandelic acid, and particularly glycolic acid are preferred. Preferred examples of monohydroxy dicarboxylic acids are tartronic acid and malic acid. Preferred examples of monohydroxy tricarboxylic acids are citric acid and isocitric acid. A preferred example of a dihydroxy dicarboxylic acid is tartaric acid.

However, particularly glycolic acid was found to possess a high efficiency in the cleaning compositions of the present invention.

The one or more hydroxy carboxylic acids (B), are contained in the cleaning composition of the invention in an amount from 10 to 60 wt.-% or 10 to 50 wt.-%, preferably 15 to 44.9 wt.-%, more preferred 20 to 39.8 wt.-% and most preferred 25 to 35.6 wt.-% based on the total weight of the cleaning composition of the invention.

### Surface Active Agents (C)

Preferably one or more surface-active agents (C) are present in the cleaning compositions of the invention.

Typical surface-active agents (C) which might be part of the cleaning compositions encompass foam control agents (C1) such as defoamers and foam inhibitors; and wetting and/or dispersing agents (C2).

The one or more surface active agents (C) are contained in the cleaning compositions of the invention in an amount from 0 to 10 wt.-% preferably 0.1 to 8 wt.-%, more preferred 0.2 to 6 wt.-% and most preferred 0.4 to 4 wt.-% based on the total weight of the cleaning composition of the invention.

### Foam Control Agents (C1)

Amongst the foam inhibitors, substances such as polysiloxanes, particularly dimethylpolysiloxanes; polyglycols; any of the afore-mentioned containing hydrophobic substances such as hydrophobic silica and hydrophobic urea; and 2,4,7,9-tetramethyl-5-decyne-4,7-diol (TMDD; VP: 0.0007 kPa, IBP: 255° C.) are preferred.

Wetting Additives and/or Dispersing Additives (C2)

Amongst the wetting and/or dispersing additives (C2) non-ionic amphiphilic surfactants such as alcohol polyethoxylates are preferred. The alcohol of the alcohol polyethoxylates preferably being an aromatic or aliphatic saturated or unsaturated, linear, or branched monoalcohol. The aliphatic saturated or unsaturated, linear, or branched monoalcohol being preferred and preferably comprising 6 to 20 carbon atoms.

### Further Ingredients (D)

### Amines (D1)

Further ingredients (D) differ from ingredients (A), (B) and (C). Such further amines (D1) are preferably secondary amines and tertiary amines, such as triethanolamine (VP: <0.001 kPa, IBP: 360° C.) and methyl diethanolamine (VP: 0.0013 kPa, IBP: 243° C.) and octyl diethanol amine.

The one or more further ingredients (D) are comprised in the cleaning composition of the invention in an amount of 0 to 10 wt.-%, preferably 0 to 8 wt.-%, more preferred 0 to 6 wt.-% and most preferred 0 to 5 wt.-% based on the total weight of the cleaning composition of the invention.

### Dicarboxylic Acids (D2)

Further ingredients may also be dicarboxylic acids, such as oxalic acid, malonic acid, succinic acid, glutaric acid, and adipic acid. Since further ingredients (D) have to differ from ingredients (A), (B) and (C), the dicarboxylic acids (D) are not to be subsumed under hydroxy dicarboxylic acids (B).

### Amounts of Ingredients in the Cleaning Compositions

The following amount ranges, preferred amount ranges, more preferred amount ranges, and most preferred amount ranges of ingredients comprised in the cleaning composition of the invention also apply to the preferred ingredients and groups of ingredients.

The cleaning composition of the present invention comprises:
40 to 90 wt.-% or 50 to 90 wt.-%, preferably 55 to 84.9 wt.-%, more preferred 60 to 79.8 wt.-% and most preferred 65 to 74.6 wt.-% of one or more glycol monoalkyl ethers (A),
10 to 60 wt.-% or 10 to 50 wt.-%, preferably 15 to 44.9 wt.-%, more preferred 20 to 39.8 wt.-% and most preferred 25 to 34.6 wt.-% of one or more hydroxy carboxylic acids (B);
0 to 10 wt.-% preferably 0.1 to 8 wt.-%, more preferred 0.2 to 6 wt.-% and most preferred 0.4 to 4 wt.-% of one or more surface active agents (C); and
0 to 10 wt.-% preferably 0 to 8 wt.-%, more preferred 0 to 6 wt.-% and most preferred 0 to 5 wt.-% of one or more further ingredients (D);
all wt.-% values being based on the total weight of the cleaning composition, and the combined amount of all ingredients being 100 wt.-%.

The cleaning compositions of the invention do preferably contain at least 80 wt.-%, more preferably 85 wt.-%, even more preferred at least 90 wt.-% and most preferred at least 95 wt.-%, such as 100 wt.-% of ingredients (A), (B), (C) and (D) in sum.

If other organic ingredients, besides (A), (B), (C) and (D) are present in the cleaning compositions of the invention, the requirements i. and ii. regarding the vapor pressure and initial boiling point should preferably apply to these ingredients likewise.

Amongst the above ranges, it is most preferred that the “preferred” ranges, the “more preferred” ranges and the “most preferred” ranges are combined.

A particularly preferred embodiment of the cleaning composition of the present invention comprises:
50 to 90 wt.-% of one or more glycol monoalkyl ethers (A), the one or more glycol monoalkyl ethers (A) being selected from mono alkylene glycol monoalkyl ethers (A1), dialkylene glycol monoalkyl ethers (A2), trialkylene glycol monoalkyl ethers (A3),
10 to 50 wt.-% of alpha-hydroxy carboxylic acids, preferably selected from monohydroxy monocarboxylic acids, monohydroxy dicarboxylic acids, monohydroxy tricarboxylic acids, dihydroxy monocarboxylic acids, dihydroxy dicarboxylic acids, and dihydroxy tricarboxylic acids (B);
0 to 10 wt.-% of one or more surface active agents (C), the one or more surface active agents (C) being selected from the group of foam control agents (C1), wetting and/or dispersing agents (C2); and
0 to 10 wt.-% of one or more further ingredients (D);
all wt.-% values being based on the total weight of the cleaning composition, and the combined amount of all ingredients being 100 wt.-%.

Another particularly preferred embodiment of the cleaning compositions of the present invention comprises:
55 to 84.9 wt.-% of one or more glycol monoalkyl ethers (A), the one or more glycol monoalkyl ethers (A) being selected from ethylene glycol monohexyl ether, propylene glycol monohexyl ether, diethylene glycol monobutyl ether, diethylene glycol monopentyl ether, diethylene glycol monohexyl ether, dipropylene glycol monobutylether, dipropylene glycol monopentyl ether and dipropylene glycol monohexyl ether, (A2), trialkylene glycol monoalkyl ethers (A3),
15 to 44.9 wt.-% of alpha-hydroxy carboxylic acids (B), selected from lactic acid, glycolic acid, mandelic acid, tartronic acid, malic acid, citric acid, isocitric acid and tartaric acid;
0.1 to 8 wt.-% of one or more surface active agents (C), the one or more surface active agents (C) being selected from polysiloxanes, polyglycols, any of the afore-mentioned containing hydrophobic substances, 2,4,7,9-tetramethyl-5-decyne-4,7-diol, and alcohol polyethoxylates; and
0 to 8 wt.-% of one or more further ingredients (D);
all wt.-% values being based on the total weight of the cleaning composition, and the combined amount of all ingredients being 100 wt.-%.

A highly preferred embodiment of the cleaning compositions of the present invention comprises:
60 to 79.8 wt.-% of one or more glycol monoalkyl ethers (A), the one or more glycol monoalkyl ethers (A) being selected from ethylene glycol monohexyl ether, diethylene glycol monobutyl ether, diethylene glycol monopentyl ether, and diethylene glycol monohexyl ether,
20 to 39.8 wt.-% of glycolic acid (B);
0.2 to 6 wt.-% of one or more surface active agents (C), the one or more surface active agents (C) being selected from polysiloxanes, polyglycols, any of the afore-mentioned containing hydrophobic substances, 2,4,7,9-tetramethyl-5-decyne-4,7-diol, and alcohol polyethoxylates; and
0 to 6 wt.-% of one or more further ingredients (D);
all wt.-% values being based on the total weight of the cleaning composition, and the combined amount of all ingredients being 100 wt.-%.
   Method for Removing a Non-Cured Aqueous Coating Material from a Surface

The present invention further relates to a method for removing a non-cured aqueous coating material from a surface, comprising the steps of
1. contacting a surface to which non-cured aqueous coating material adheres with a cleaning composition according to the invention or its dilution in an aqueous medium; and agitating the cleaning composition or its dilution in an aqueous medium, while the non-cured aqueous coating material dissolves and/or disperses therein,
2. removing the cleaning composition or its dilution in an aqueous medium and the therein dissolved and/or dispersed coating material from the surface, and
3. rinsing the surface with an aqueous medium.

### Non-Cured Aqueous Coating Materials

The non-cured aqueous coating materials which are to be removed from surfaces by using the method according to the invention are preferably dip-coat coating materials, particularly preferred electrodeposition coating materials, even more preferred cathodic electrodeposition coating materials.

Such cathodic electrodeposition coating materials typically contain amino-functional binders, which are converted, for the coating process, into the water-dilutable form by carboxylic acid such as formic acid. During the deposition process, the positively charged coating material particles migrate and diffuse to the workpiece connected as cathode, react with hydroxide ions, and are deposited as water-insoluble polyamines on the workpiece. The binders used typically include adducts of epoxy resins and polyamines, or amino-functional poly(meth)acrylates; both of which are typically crosslinked with blocked polyisocyanates at elevated temperatures.

Electrodeposition coating materials preferably have solids contents of about 20 to 40 wt.-% based on the weight of the coating material. However, the solids content in the deposited coating film is typically 80 to 90 wt.-% based on the weight of the wet coating film. Besides the positively charged binders, which mostly are contained in an amount of 10 to 15 wt.-%, cathodic electrodeposition coating materials also contain pigments, and a small proportion of organic solvents as solubilizers. Further contained are additives and water. Electrodeposition coating materials for primer coatings are mostly colored gray or black and contain anti-corrosion pigments.

For the application of electrodeposition coating materials on electrically conductive substrates, the workpiece is immersed in an electrodeposition coating material bath. Between the workpiece and a counter electrode, a DC field is applied, the ionized coating material discharges and coagulates on the workpiece. The deposited paint film has typically, as already stated above, a solids content in the range of 80 to 90 wt.-% and is no longer dilutable with water, so that the adhering bath liquid can be rinsed off with water. The final coating is formed by curing the deposited coating material at temperature in the range of typically 120 to 180° C.

From time to time the tanks containing the coating material baths, the installations in such tanks and equipment must be thoroughly cleaned, i.e., adhering coating material in liquid or dried-on form, however non-cured, must be removed from the respective surfaces of the tanks, installations associated therewith and equipment used as well as from exterior surface and floors etc. which might have been spilled.

### Step 1

In Step 1 the surface to which non-cured aqueous coating material adheres is contacted with a cleaning composition of the invention or preferably its dilution in an aqueous medium.

The terms “non-cured” or “uncured” mean that the coating material is in liquid form and/or in dried-on form, but not crosslinked or cured as required for the coated workpieces.

The surface to which non-cured aqueous coating material adheres can be any surface which was in contact with a non-cured aqueous coating material, particularly a dip-coating material, more particular an electrodeposition coating material, and even more particular a cathodic electrodeposition coating material, as described above.

The surface can, e.g., be the surface of a dip-coating tank, particularly an electrodeposition dip-coating tank, surfaces of any installations associated therewith, such as surfaces of skids for transporting to be coated workpieces through the coating material, but also surfaces of pipes and the like through which coating material is transported. Furthermore, exterior surfaces and surfaces of equipment being in contact with the coating material as well as floors and the like.

Preferably and typically, the surfaces to which non-cured aqueous coating material adheres are metallic surfaces, but not necessarily, because floors etc. which may be made of other materials can also be cleaned.

Contacting the surface to which non-cured aqueous coating material adheres can be accomplished by any means, e.g., brushing, dipping, spraying, or filling a tank with the cleaning composition according to the invention or with its dilution in an aqueous medium.

While it is possible to use the cleaning compositions of the present invention in undiluted, i.e., pure form, it is in most cases not necessary to use the concentrate, or even preferred to use the cleaning composition of the invention in form of its dilution in an aqueous medium. The term “aqueous medium” as used herein denotes any medium which is based on water and contains water as its main ingredient and which does not interfere with the aim of the invention to provide cleaning without use of VOC containing compounds.

Thus, the “aqueous medium” does not contain organic ingredients having a vapor pressure of 0.01 kPa or more at 20° C. Preferably the “aqueous medium” is water, even more preferred deionized water.

Suitable dilutions of the cleaning composition in aqueous medium, preferably in water, preferably contain at least 0.5 wt.-% of the cleaning composition according to the invention. Depending on the purpose and degree of contamination different concentrations are sufficient or required.

Typical concentrations of the cleaning composition of the invention in the aqueous medium, preferably water range from 0.5 to 50 wt.-%, which is also the range for cleaning of exterior surfaces and floors. For the cleaning of uncured electrophoretic paint installations, such as vats, pipelines, exchangers, or others, it is, e.g., preferred to use concentrations of the cleaning composition of the invention in the aqueous medium in the range from 0.5 to 2.0 wt.-%. For removal of uncured electrophoretic paint from installations, such as pendulums, fasteners, or others, it is often preferred to use concentrations of the cleaning composition of the invention in the aqueous medium in the range from 2.0 to 40 wt.-%, more preferred 3.0 to 30 wt.-%, such as, e.g., from 10 to 25 wt.-%.

The contacting time depends on the thickness of the layer of non-cured coating material which adheres to the surface and is preferably at least 1 min, but may also be, e.g., up to 7 days. Typically, it is in the range from 5 min to 4 days, more preferred in the range from 15 min to 3 days, such as in the range from 30 min to 2 days.

The contacting temperature, i.e., the temperature of the cleaning composition of the invention or its dilution in an aqueous medium, preferably water, preferably ranges from 10 to 60° C., more preferred from 20 to 50° C.

While being in contact with the surface to which non-cured aqueous coating material adheres, the cleaning composition of the invention or its dilution in an aqueous medium is agitated, e.g., stirred or shaken to intensify the contact and to facilitate dissolving and/or dispersing the coating material to remove it from the surface. A particular type of agitation is the repeated circulation of the cleaning composition, preferably a water-diluted cleaning composition by use the process pumps.

### Step 2

After Step 1 the cleaning composition or its dilution in an aqueous medium and the therein dissolved and/or dispersed coating material are removed from the surface, i.e., separated from the surface. This can be done by any known means, such as pouring out the tank, pumping off the used cleaning composition and the like.

### Step 3

After Step 2, the thus cleaned surfaces are rinsed with an aqueous medium, preferably with water. Rinsing in Step 3 can be carried out in one step or several consecutive steps, e.g., by removing the first rinse containing the main residues of the cleaning composition and the therein dissolved and/or dispersed coating material, followed by one or more further rinses until the aqueous medium as clean as desired. Rinsing can of course be carried out by any known means. Particularly the first, and sometimes the second rinse may be carried out with the aqueous medium, preferably water, under high pressure, while later rinses may only be carried out by repeated circulation of the aqueous medium, by use of the process pumps.

If in some cases, if there is a persistent adhesion of the coating material to the surface, the method can of course be repeated, if necessary, with a higher concentration of the cleaning composition of the invention in the aqueous medium and/or with longer contacting times and/or higher contacting temperatures and/or intensified agitation.

In the method according to the invention any general or specific embodiments of the cleaning compositions according to the invention or their dilutions in aqueous media can be used.

### Use of the Cleaning Compositions of the Invention for Cleaning Surfaces

Further subject of the present invention is the use of the cleaning compositions of the present inventions for cleaning surfaces to which non-cured aqueous coating materials adhere.

The surfaces are preferably the same as described for the method of the invention as well as the non-cured aqueous coating materials are preferably the same as described above.

In the use according to the invention any general or specific embodiments of the cleaning compositions according to the invention or their dilutions in aqueous media can be used.

In the following the invention is exemplified by means of a working example.

### Example

### Determination of Parameters

### Determination of the Vapor Pressure at 20° C.

The vapor pressure being determined according to OECD/OCDE Guidelines for the testing of Chemical 104 (adopted Mar. 23, 2008), using the gas saturation method.

### Determination of the Initial Boiling Point at 101.3 kPa

The initial boiling point being determined according to OECD/OCDE Guidelines for the testing of Chemical 103 (adopted Jul. 27, 1995), using the dynamic method.

### Preparation of a Cleaning Composition and its Dilution in Water

A cleaning composition was obtained by mixing the ingredients shown in Table 1:

TABLE 1

| | | Amount |
|---|---|---|
| Ingredients | Type | [wt.-%] |
| Diethylene glycol monobutyl | Glycol monoalkyl ether (A)¹ | 65 |
| ether | | |
| Diethylene glycol monohexyl | Glycol monoalkyl ether (A)¹ | 3 |
| ether | | |
| Monoethylene glycol hexyl ether | Glycol monoalkyl ether (A)² | 2 |
| Glycolic Acid | Hydroxy Carboxylic Acid (B) | 30 |
| TMDD | Surface Active Agent (C)³ | 1 |

¹Dialkylene glycol monoalkyl ether (A2)
²Monoalkylene glycol monoalkyl ether (A1)
³Foam Control Agent (C1)

Methods of Cleaning a Surface with the Cleaning Compositions

### Cleaning an Electrodeposition Dip Coating Tank

First, an electrodeposition dip coating tank was emptied to a storage tank. In a second step the tank was pre-cleaned manually with high pressure to remove big paint particles from the facility. Subsequently, the tank was filled to 80% with de-ionized water and the cleaning composition of Table 1 was added to a concentration of 0.8% (v/v). The tank was filled with de-ionized water until the working level (100%) was reached. Then, the 5 or 10 μm multi-layer filters were removed to facilitate the recirculation. Subsequently, the valves were opened to allow maximum recirculation flow. Recirculation was started carried out for about 48 hours. Then recirculation was stopped and the diluted cleaning composition containing the dissolved and dispersed paint residues was removed. Afterwards, it was again manually cleaned with water using high pressure to remove dissolved paint particles from the facility. The filters were put on again and the tank was filled with deionized water, which was recirculated for about 2 hours. The water was removed and the tank was refill again with fresh de-ionized water for a second rinsing. The filters were checked and replaced by new ones. Finally, the tank was ready to be re-filled with the electrodeposition dip coating material, which was transferred back from storage tank into the electrodeposition dip coating tank. The cleaning procedure showed very good results.

### Cleaning an Organic Dip Coating Tank

In laboratory experiment the cleaning composition of Table 1 was diluted with water to a final concentration of 10 wt.-% based on the total weight of the water-diluted cleaning composition.

A small stainless-steel tank was applied with an organic dip coating material and left drying for 120 h at room temperature. Subsequently, the tank was filled a 10 wt.-% solution of the formulation in Table 1 in water and kept agitating for 60 min at room temperature. Afterwards the water-diluted cleaning composition was removed and the tank was rinsed with water. The dissolution rate was very high and cleaning showed good to very good results.

### Further Experiments

Similar experiments were carried out with other surfaces such as regular steel, plastic parts, composites (glass fiber, glass) to which regular organic dip coating material or cathodic electrodeposition coating material adhered. The water-diluted cleaning compositions were recirculated using process pumps for 1 to 2 days at different conditions such as lower and higher concentrations and temperatures. Typically, the temperatures used were room temperature (about 23° C.). Again, the dissolution rate was very high and cleaning showed good to very good results.

As comparative examples similar solutions using acetic acid and no glycolic acid were used. In such cases only up to average results were achieved.

1. A cleaning composition comprising
a. 40 to 90 wt.-% of one or more glycol monoalkyl ethers (A), which are selected from the group consisting of mono alkylene glycol monoalkyl ethers (A1), dialkylene glycol monoalkyl ethers (A2), trialkylene glycol monoalkyl ethers (A3), and tetraalkylene glycol monoalkyl ethers (A4);
b. 10 to 60 wt.-% of one or more hydroxy carboxylic acids (B);
c. 0 to 10 wt.-% of one or more surface active agents (C); and
d. 0 to 10 wt.-% of one or more further ingredients (D) which differ from (A), (B) and (C), selected from the group consisting of secondary amines, tertiary amines, and dicarboxylic acids;
all the above ingredients having
i. a vapor pressure at 20° C. of less than 0.01 kPa, and/or
ii. an initial boiling point of more than 250° C. at a pressure of 101.3 kPa;
all wt.-% values being based on the total weight of the cleaning composition, and the combined amount of all ingredients being 100 wt.-%.

2. The cleaning composition according to claim 1, wherein the one or more glycol monoalkyl ethers (A) are selected from the group consisting of
ethylene glycol monoalkyl ethers (A1) and propylene glycol monoalkyl ethers (A1), which have the following formula HO—R—O—R^{a}, wherein R^{a} is a linear or branched alkyl residue having 6 to 10 carbon atoms;
diethylene glycol monoalkyl ethers (A2) and dipropylene glycol monoalkyl ethers (A2) which have the following formula HO—(R—O—)₂R^{b}, wherein R^{b} is a linear or branched alkyl residue having 4 to 10 carbon atoms;
triethylene glycol monoalkyl ethers (A3) and tripropylene glycol monoalkyl ethers (A3) which have the following formula HO—(R—O—)₃R^{c}, wherein R^{c} is a linear or branched alkyl residue having 1 to 10 carbon atoms; and
tetraethylene glycol monoalkyl ethers (A4) and tetrapropylene glycol monoalkyl ethers (A4) which have the following formula HO—(R—O—)₄R^{d}, wherein R^{d} is a linear or branched alkyl residue having 1 to 10 carbon atoms;
and wherein in any of the glycol monoalkyl ethers (A1), (A2), (A3) and (A4), residues R—O independently of each other are ethylene oxide or propylene oxide residues.

3. The cleaning composition according to claim 1, wherein the glycol mono alkylethers (A) are selected from the group consisting of mono alkylene glycol monoalkyl ethers (A1), dialkylene glycol monoalkyl ethers (A2), trialkylene glycol monoalkyl ethers (A3), and mixtures thereof.

4. The cleaning composition according to claim 1, wherein the glycol mono alkylethers (A) are selected from the group consisting of mono ethylene glycol monoalkyl ethers (A1), diethylene glycol monoalkyl ethers (A2), triethylene glycol monoalkyl ethers (A3), and mixtures thereof.

5. The cleaning composition according to claim 1, wherein the glycol monoalkyl ethers (A) are selected from the group consisting of the mono alkylene glycol monohexyl ethers (A1), dialkylene glycol monohexyl ethers (A2), and dialkylene glycol monobutyl ethers (A2).

6. The cleaning composition according claim 1, wherein the hydroxy carboxylic acid (B) is glycolic acid.

7. The cleaning composition according to claim 1, wherein the surface-active agents (C) are selected from the group consisting of foam control agents (C1) and wetting and/or dispersing agents (C2).

8. The cleaning composition according to claim 7, wherein
the foam control agents (C1) are selected from the group consisting of polysiloxanes, polyglycols, any of the afore-mentioned containing hydrophobic substances, and 2,4,7,9-tetramethyl-5-decyne-4,7-diol; and/or
the wetting and/or dispersing agents (C2) are selected from the group consisting of non-ionic amphiphilic surfactants.

9. The cleaning composition according to claim 1, wherein further ingredients (D) are selected from the group consisting of tertiary amines.

10. The cleaning composition according to claim 1, wherein the composition comprises
55 to 84.9 wt.-% of one or more of the glycol monoalkyl ethers (A),
15 to 44.9 wt.-% of one or more of the hydroxy carboxylic acids (B),
0.1 to 8 wt.-%, one or more of the surface-active agents (C), and
0 to 8 wt.-%, of one or more of the further ingredients (D),
all wt.-% values being based on the total weight of the cleaning composition, and the combined amount of all ingredients being 100 wt.-%.

11. The cleaning composition according to claim 1, that wherein the composition comprises
60 to 79.8 wt.-% of one or more glycol monoalkyl ethers (A), the one or more glycol monoalkyl ethers (A) being selected from the group consisting of ethylene glycol monohexyl ether, diethylene glycol monobutyl ether, diethylene glycol monopentyl ether, and diethylene glycol monohexyl ether;
20 to 39.8 wt.-% of glycolic acid (B);
0.2 to 6 wt.-% of one or more surface active agents (C), the one or more surface active agents (C) being selected from the group consisting of polysiloxanes, polyglycols, any of the afore-mentioned containing hydrophobic substances, 2,4,7,9-tetramethyl-5-decyne-4,7-diol, and alcohol polyethoxylates; and
0 to 6 wt.-% of one or more further ingredients (D);
all wt.-% values being based on the total weight of the cleaning composition, and the combined amount of all ingredients being 100 wt.-%.

12. A method for removing a non-cured aqueous coating material from a surface, comprising the steps of
a) contacting a surface to which non-cured aqueous coating material adheres with a cleaning composition according to claim 1, or its dilution in an aqueous medium; and agitating the cleaning composition or its dilution in an aqueous medium, while the non-cured aqueous coating material dissolves and/or disperses therein,
b) removing the cleaning composition or its dilution in an aqueous medium and the therein dissolved and/or dispersed coating material from the surface, and
c) rinsing the surface with an aqueous medium.

13. The method according to claim 12, wherein the non-cured aqueous coating material is a liquid and/or dried-on dip-coating material selected from the group consisting of electrodeposition coating material and other dip-coating materials; and/or
the aqueous medium is water; and/or
the dilution of the cleaning composition in an aqueous medium contains at least 0.5 wt.-% of the cleaning composition.

14. The method according to claim 12, wherein
contacting the surface to which non-cured aqueous coating material adheres with the cleaning composition or its dilution in an aqueous medium is carried out for at least 1 minute; and/or
the cleaning composition or its dilution in an aqueous medium having a temperature in the range from 10 to 60° C.

15. A method of using the cleaning composition according to claim 1 or its dilution in an aqueous medium, the method comprising using the cleaning composition or its dilution in an aqueous medium for cleaning substrates to which non-cured aqueous coating materials adhere.
